(19) United States
(12) Patent Application Publication
(10) Pub. No.: US 2006/0271434 A1
(43) Pub. Date: Nov. 30, 2006

(54) System and Method for a Computerized Advertisement Development Tool

(75) Inventors: Mark R. Ruttenberg, Bloomington, IL (US); Steven R. Yerbic, Canton, IL (US)

Correspondence Address: THOMPSON COBURN, LLP, ONE US BANK PLAZA, SUITE 3500, ST LOUIS, MO, 63101, US

(73) Assignee: MONARCH VISUAL SOLUTIONS, INC., Normal, IL (US)

(21) Appl. No.: 11/420,964

(22) Filed: May 30, 2006

Related U.S. Application Data
(60) Provisional application No. 60/595,020, filed on May 30, 2005.

(51) Int. Cl. G06Q 30/00

(52) U.S. Cl. 705/14

(57) ABSTRACT

A computerized advertisement development tool and associated method of use that includes creation of stock electronic advertisements and custom electronic advertisements that appear on an electronic display. The customized electronic advertisements include: 1) bullet point effects; 2) photographic effects: 3) a motion picture effect that is either video or a virtual motion image created from still photographs; and 4) text effects. There is a contract that provides scheduling between a plurality of sponsored electronic advertisements and a plurality of timed events. This can include following a block of sponsored electronic advertisements, playing after a predetermined number of sponsored electronic advertisements, playing after a predetermined time period, or playing after a predetermined percentage of sponsored advertisements. The timed events can include trivia, community events, amber alerts, sponsor boards, weather, headlines, special events and user created events. The timed events can be blended in relationship to each other based on predetermined percentages.

### CROSS-REFERENCE TO RELATED APPLICATION

This patent application claims priority to U.S. Provisional Patent Application Ser. No. 60/595,020 filed May 30, 2005, the disclosure of which is incorporated herein by reference.

### BACKGROUND OF INVENTION

Electronic displays are commonly used in public facilities to display various types of advertisements. There are also systems comprising a network of electronic displays whose display content is controlled from a central control system. The owner of the electronic display network can offer broadcast time to prospective clients. Graphical advertisements can be created on the client's behalf and subsequently electronically transmitted and displayed over the display network.

Designing and producing graphical designs, such as advertising that will be presented on electronic displays, can be a time consuming and labor intensive process. A customer requiring an advertisement may work with an artist or group of artists or graphic designers in an iterative process to design the content for the advertisement. The customer may set forth various specifications as to what the content should be or how it should appear when presented on an electronic display. The artist or graphic designer would then interpret the customer defined specifications and create an original graphic design representing the desired graphic content for the advertisement. The creation of the graphic design for advertisements to be presented on an electronic display typically involves the use of computer-aided design tools. The customer will typically review the graphic design and then review the electronic display presentation. If the customer is satisfied, the electronic display presentation is usually stored on electronic media in an executable format for use by a system for display on a network of electronic displays.

Therefore, it is desirable to provide a computer-implemented system to facilitate allowing the customer to interactively design and produce customized advertisements that are uploadable/downloadable onto systems for display on a network of electronic displays. There is also a need to intersperse timed events with sponsored advertisements that can vary based on the desires of each individual customer. Also, there is a need to change the sponsorship of various timed events when desired.

The present invention is directed to overcoming one or more of the problems set forth above.

### SUMMARY OF INVENTION

This invention relates generally to electronic display of advertisements and, more particularly, to the creation of stock advertisements and custom advertisements that appear on an electronic display.

The invention is a computerized advertisement development tool and associated method of use. The invention includes the creation of stock advertisements and custom advertisements that will appear on an electronic display. The customized advertisements include: 1) bullet point effects, e.g., appear one line of text at a time, appear with checkmarks by each line of text, appear with a new color for each new line of text, and appear with all text simultaneously at one time and slide-in from the side; 2) photographic effects, e.g., a wipe effect for a photograph, a spin effect for a photograph, a fade-in effect for a photograph, a roll effect for a photograph and a fade-out effect for a photograph; 3) a motion picture effect that is either video or a virtual motion image created from still photographs. This virtual motion image can include image rotation, e.g., 360 degrees, using several photographs to create an illusion of motion and a pan scan; 4) text effects that can include fade-in, fade-out, flash, move-in, move-out, a marquee scroller, roll text and spin text.

Therefore, a customized advertisement can literally be created at the advertiser's location with very little effort by utilizing, for example, a laptop PC having the computerized development tool installed and then uploaded/downloaded into the system for display on a network of electronic displays. The stock advertisement components include selected previously developed graphical images with the addition of new text for that particular advertiser.

The invention can include a computer implemented system for creating and uploading/downloading advertisements for presentation on electronic displays. The system can comprise a user interface for selecting and laying out graphical images that are stock images or input customized images and the system can include functionality for adding textual information to create an advertisement. The system can further include a user interface application residing on an application server accessible over a wide area network (WAN) that can be operable to generate and present the user interface displays prompting the customer to make graphical and textual selections. The system can further include a storage medium that can be connected to the application server for storing the graphical and textual information selected by the customer. The system can further include a graphics engine that can be operably connected to the application server and the storage medium for building an executable graphical advertisement display function and executing the display function presenting the graphically created advertisement on the user interface for customer review. The system can also include an upload/download function for providing graphical advertisements to a system network of electronic displays. The development tool and user interface application can also reside on a network as well as a portable laptop PC.

A customized advertisement can literally be created by the customer on the customer's personal computer at the customer's location with very little effort and without contracting with a graphic artist. The executable display function can then be provided to the system for display on a network of electronic displays, without a long turn-around time. These and other advantageous features of the present invention will be in-part apparent and in-part pointed out herein below.

Another aspect of this invention is that a computer implemented system for creating and uploading/downloading stock and customized advertisements for presentation on electronic displays is disclosed. This system includes a user interface for selecting graphical images and for adding textual information to create the advertisement, a user interface application residing on an application server that is operable to generate and present the user interface displays prompting the customer to make graphical and textual selections, a storage medium that can be connected to the application server for storing the graphical and textual information selected by the customer.

Yet another aspect of this invention is that a computer implemented system for creating and uploading/downloading stock and customized advertisements for presentation on electronic displays is disclosed. This system includes a graphics engine that is operably connected to an application server and a storage medium for building an executable graphical advertisement display function and executing the display function by presenting the graphically created advertisement on the user interface for customer review.

Still another aspect of this invention includes a function for uploading/downloading, transmitting or receiving an executable function with a system network of electronic displays. This can include providing scheduling between at least one sponsored advertisement and at least one timed event, wherein the timed event can include at least one of trivia, community events, amber alerts, sponsor boards, weather, headlines, special events and user-created events. This can also include providing a plurality of replacements of a sponsor for a particular timed event. The scheduling of the at least one timed event is by one of the following techniques that include following after a block of sponsored advertisements, playing after a predetermined number of sponsored advertisements, playing after a predetermined amount of elapsed time, e.g., number of seconds, playing after a predetermined percentage of sponsored advertisements, and blending at least one timed event with at least one other timed event based on a predetermined percentage.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 is representative of a user interface screen shot of the load advertiser interface;

FIG. 2 is representative of a user interface screen shot of the advertiser search interface;

FIG. 3 is representative of a user interface screen shot of the advertiser information interface;

FIG. 4 is representative of a user interface screen shot of the address book interface;

FIG. 5 is representative of a user interface screen shot of the basic information interface;

FIG. 6 is representative of a user interface screen shot of the Logo Resource interface;

FIGS. 7-11 are representative of user interface screen shots of the build stock advertisement interface;

FIGS. 12-15 are representative of user interface screen shots of the build stock advertisement interface;

FIG. 16 is representative of a user interface screen shot of the contract book interface;

FIG. 17 is a functional flow diagram of the advertisement build process;

FIG. 18 is a functional diagram of the computerized advertisement build system;

FIG. 19 is representative of a screen shot of a community with interchangeable sponsorships; and

FIG. 20 is representative of a user interface screen shot for managing timed events in conjunction with sponsored or regular advertisements.

### DETAILED DESCRIPTION OF THE INVENTION

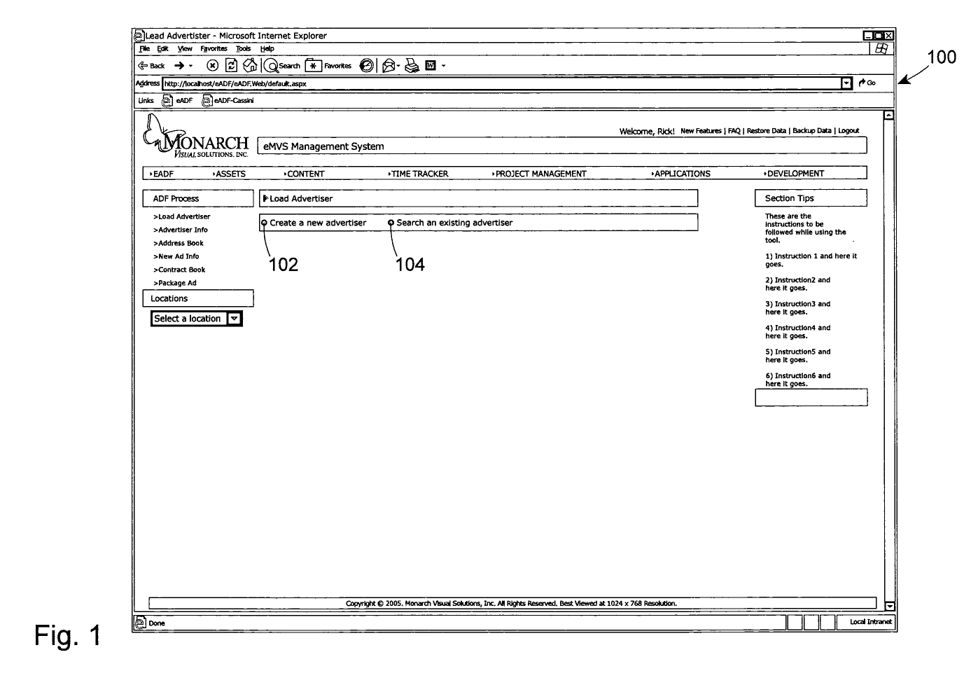

According to the embodiment(s) of the present invention, various views are illustrated in FIGS. 1-20 and like reference numerals are being used consistently throughout to refer to like and corresponding parts of the invention for all of the various views and figures of the drawing. Also, please note that the first digit(s) of the reference number for a given item or part of the invention corresponds to the Fig. number in which the item or part is first identified.

One embodiment of the present invention comprising of a computerized advertisement development tool that teaches a novel system and method for creation of stock advertisements and customized advertisements that are capable of being provided to a network of displays.

The details of the invention and various embodiments can be better understood by referring to the figures of the drawing. Referring to FIG. 1, a typical screen shot of the user interface is shown for the computerized advertisement development tool. The developmental tool can utilize a standard browser interface environment such as the MICROSOFT INTERNET EXPLORER® application as shown. MICROSOFT INTERNET EXPLORER® is a federally registered trademark of the Microsoft Corporation having a place of business at One Microsoft Way, Redmond, Wash. 98052-6399. The user interface application can be executed in this or other similar browser environments. Although this browser-based configuration is shown in FIGS. 1 through 20 of this application, similar type user interface application environments could be utilized to accomplish the same task.

FIG. 1 specifically shows the load advertiser screen shot 100, which is initially presented when the application is launched. This user interface page allows the user to select between creating 102 a new advertisement or searching 104 for an existing advertisement that has been previously created. Again, the information or data required is used to create the new advertisement or searching for an existing advertisement can be located on a personal computer or can be accessed via local area network or accessed via a wide area network such as the Internet. If the information for creating the advertisement is local to a PC, then the user interface application can be a PC based application that can be executed utilizing a standard operating system such as WINDOWS XP®. WINDOWS XP® is a federally registered trademark of the Microsoft Corporation having a place of business at One Microsoft Way, Redmond, Wash. 98052-6399. However, if the information is accessed via a local area network or a wide area network, the application can be a browser-based application allowing the user to access centralized data and information for creating the advertisement.

Portable laptop PC's have sufficient processing capability and memory capacity to host the subject computerized advertisement development tool. Current technology laptop PC's are more than adequate to host a graphics generation engine as defined by the present invention. Furthermore, current technology operating systems are adequate to support the subject development tool. Also, in addition to operating as a stand-alone PC, the laptop PC can also utilize wireless technology to access a wide area network such as the internet or a local area network. When utilizing wireless technology, the computerized advertisement development tool can be a browser based application which utilizes the benefits of a typical browser such as MICROSOFT INTERNET EXPLORER®. The screen shots shown in FIGS. 1 through 20 are representative of the browser-based embodiment.

The load advisor screen shot, shown in FIG. 1, provides a user interface screen that allows the user to select the options of creating a new advertiser presentation or search for an existing advertiser presentation currently stored locally on the PC or stored at some remote central location. For example, an advertising sales representative could utilize this tool hosted on a laptop PC to develop a proposed graphical advertisement for a prospective customer. The sales representative could dynamically develop the advertisement and present the graphical presentation to the prospective customer without having to go through various iterations of the development process. Once the graphical presentation has been completed, the sales representative can then upload/download or transmit the graphical presentation created to a system that is communicably linked to a network of displays remotely located at various locations. For example, a centralized server can be communicably linked over a wide area network to various display devices remotely located at various locations such as a shopping mall.

One possible business model is where an advertising agency can have one or more servers, e.g., centralized, that are communicably linked over a wide area network to a network of displays operable to receive and display graphical presentations of various advertisements. The advertising agency could provide to prospective customers the ability to display a graphical presentation of the prospective customers' advertisement on the various displays within the network. An audio component for the advertisement may optionally be present.

Therefore, the present invention is a computerized advertisement development tool that can be utilized by a sales representative to create and present dynamically proposed graphical presentations for advertisements to a prospective customer and then subsequently upload/download or transmit the advertisement created to the network of electronic displays.

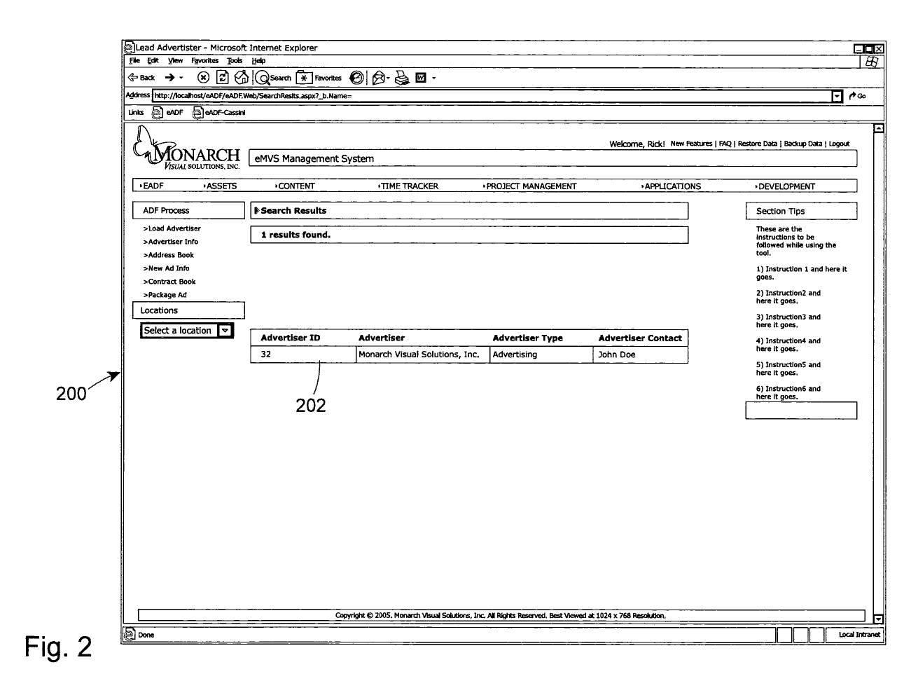

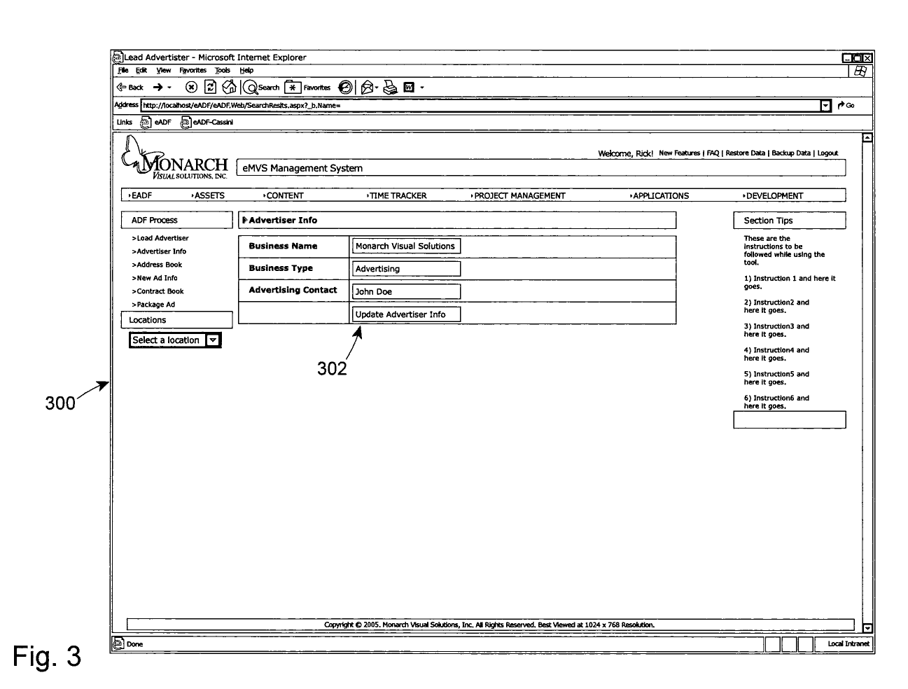

Referring to FIG. 2, a screen shot is shown that is representative of a search result 200 where the user has opted to select the option of searching for an existing advertiser and has input the appropriate information such as advertiser identification (i.d.) or an advertiser name so that a search result is generated and presented 202 as shown in the screen shot in FIG. 2. FIG. 3 is representative of a screen shot where the advertiser info option has been selected 300, whereby basic advertiser information 302 is shown such as the business name, business type and contract.

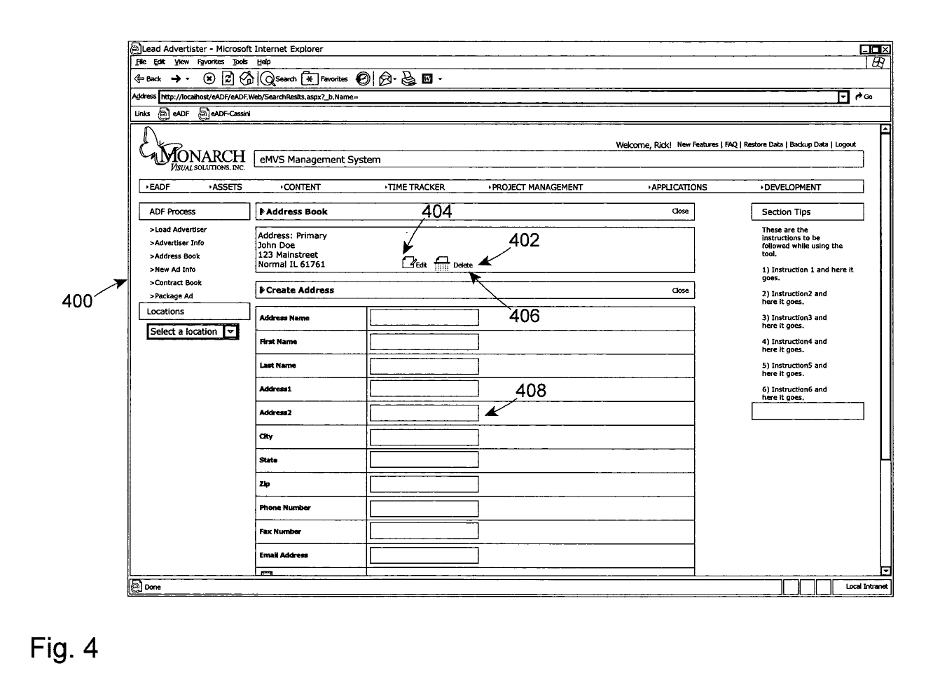

FIG. 4 is representative of a screen shot that shows the presentation when the address book option has been selected 400 so that the address of the primary contact is shown 402. This user interface screen allows the user to edit 404 the address shown or the option of deleting 406 the address. Furthermore, this user interface screen provides the user with the option of creating a new address by inputting the appropriate information into the fields 408 provided.

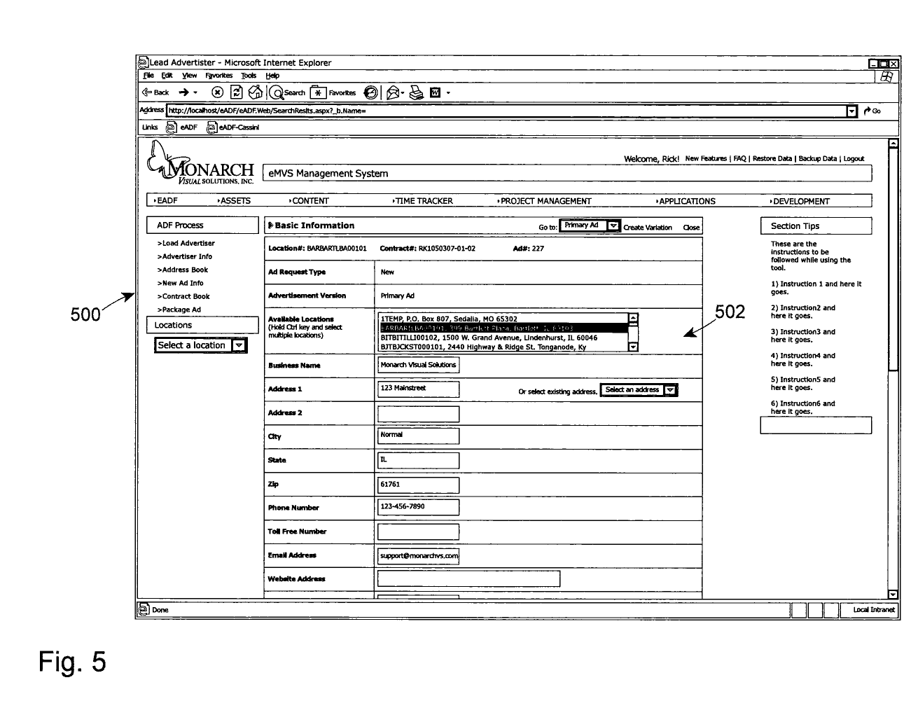

FIG. 5 is representative of the basic information screen shot 500 which allows the user to input basic information 502 concerning an advertisement that is to be created or to edit basic information for an existing advertisement. The basic information includes contact information, version of the advertisement and the available locations that are selected for a given advertisement.

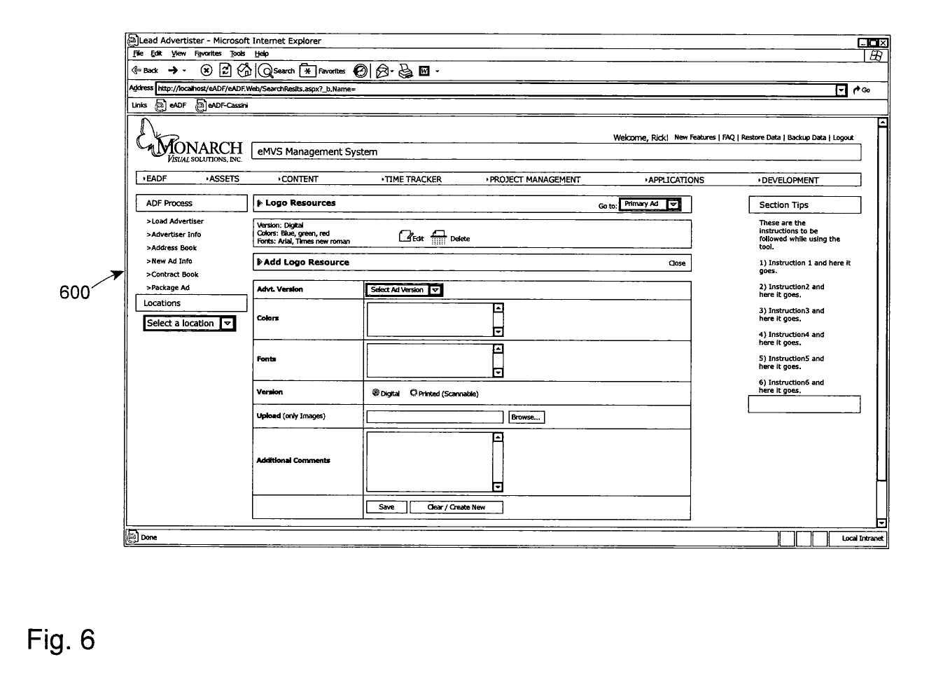

FIG. 6 is representative of the logo resources user interface screen shot 600. This particular user interface screen allows the user to define the logo to be utilized in conjunction with the advertisement. Colors and fonts can be selected and images can be scanned and uploaded into the application and subsequently utilized in the graphical presentation for the advertisement. Various other still images or video images can be uploaded into the application for utilization in the advertisement.

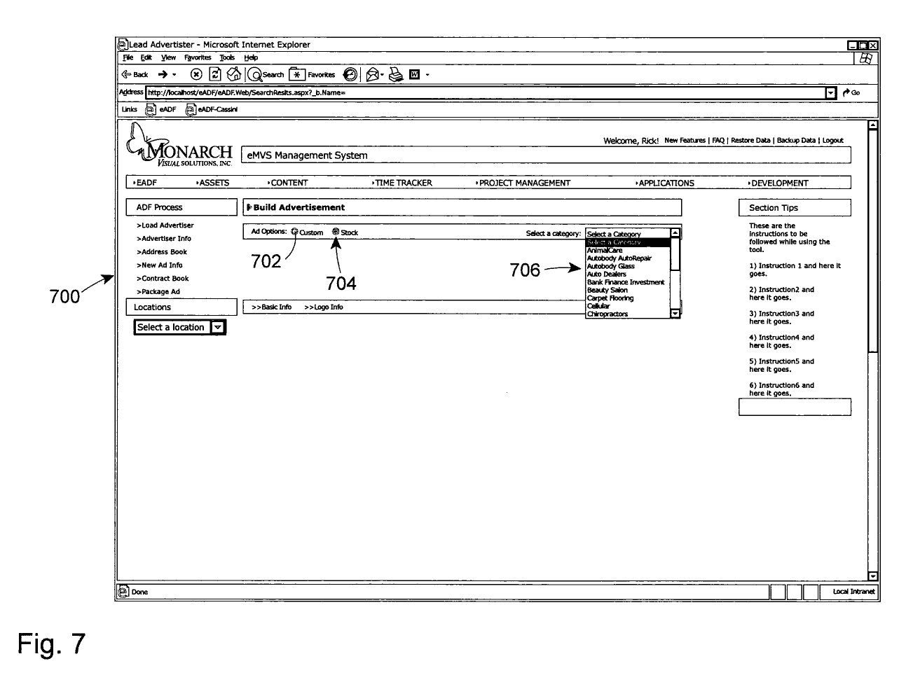

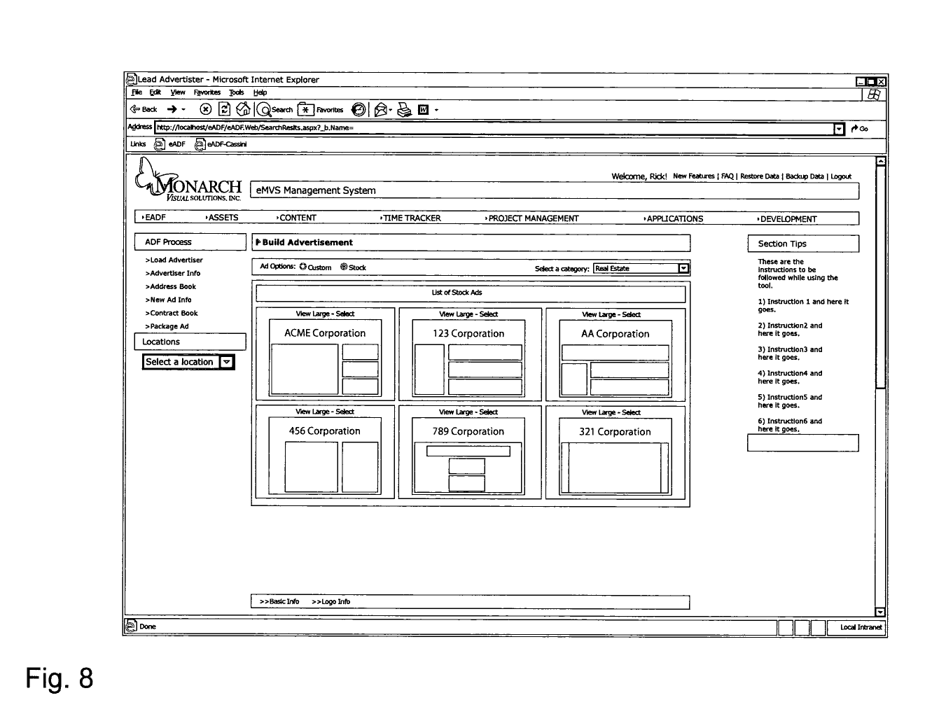

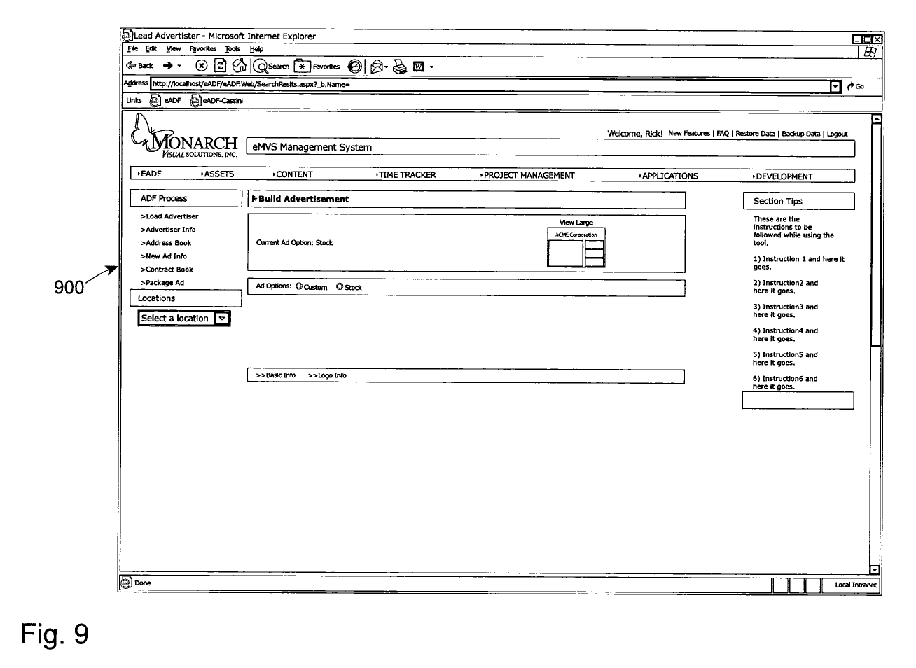

FIG. 7 is representative of a user interface screen shot for initializing the build-advertisement function 700. The user is provided with the option of creating a customized graphical presentation 702 or utilizing various stock presentations 704 that are stored and accessible by the application. If the stock option is selected, the user will then have the option of selecting from among various categories 706, wherein each category contains stock graphical presentations that can be utilized in the advertisement to be created. For example, FIG. 8 reflects a screen shot where the user has selected the stock presentation material option and has selected the real estate category whereby the list of stock ads for that category is presented. The user or sales representative can then review the stock ads with a prospective customer and make the appropriate selection. FIG. 9 is representative of a user interface screen shot where a stock ad option has been selected 900 and is clearly displayed to the user.

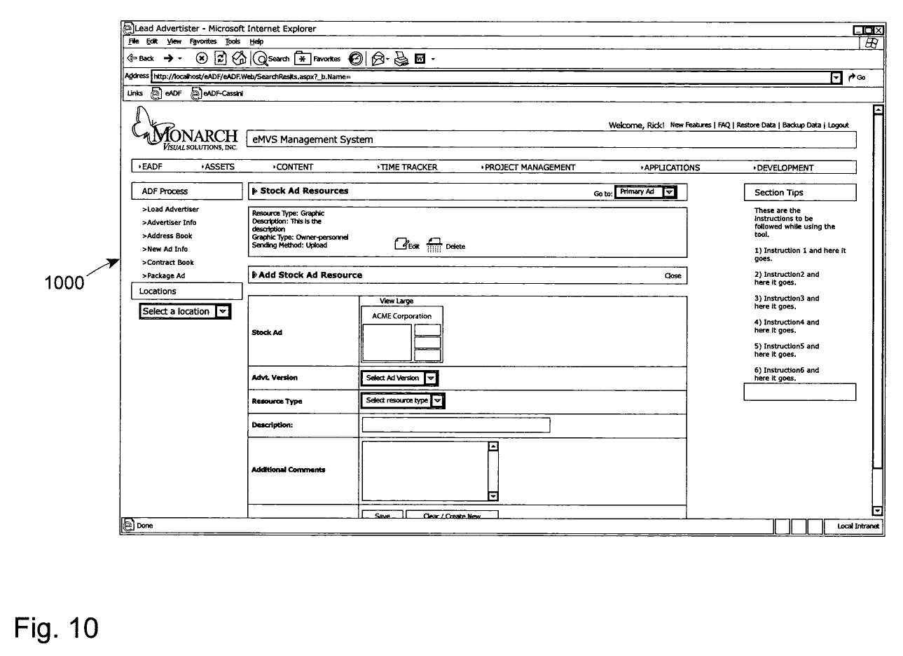

FIG. 10 is representative of a user interface screen shot that allows the user to review the stock ad resources 1000 including the stock ad itself, the advertisement version, the resource type such as graphical information, textual information, a brief description of the stock advertisement, and so forth.

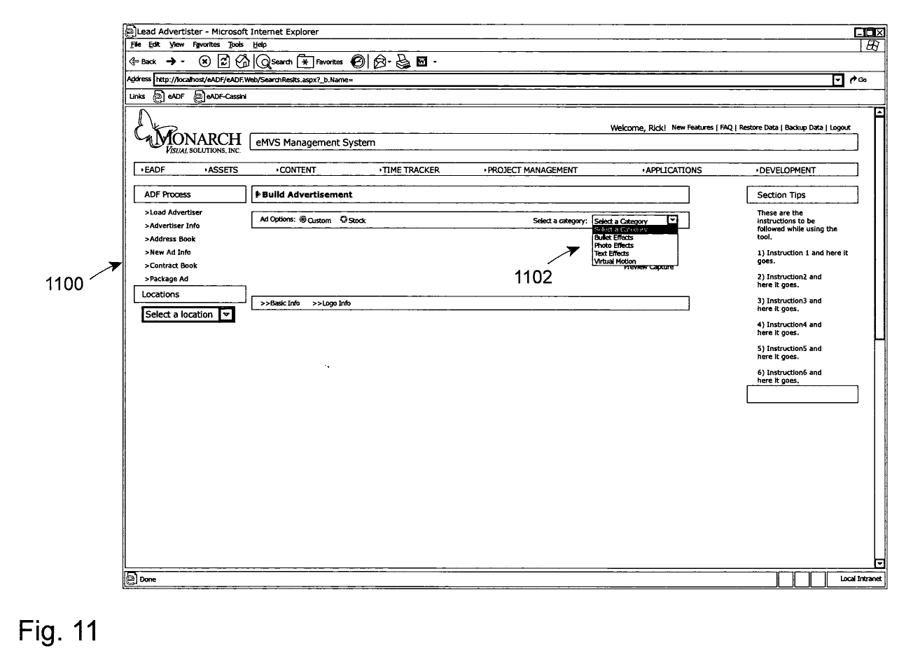

FIG. 11 is representative of a user interface screen shot where the user has selected the custom build advertisement option 1100. This is where the user is allowed to select from a category of custom-type ads 1102 including bullet effects, photo effects, text effects and virtual motion. For example, the bullet effects option allows the graphical presentation to be generated such that one line of text appears at a time and each line of text appears with a check mark or other indicator adjacent the line of text. Each line of text, as it is presented, can be viewed in a different color. Photographic effects could include for example a photograph wipe effect, a spin effect, a fade-in and fade-out effect, a rolling effect and other various photographic effects. The motion picture effect could include for example either a video or a virtual motion image created from various still photographs. This virtual motion image can include image rotation, e.g., 360 degrees, using several photographs to create an illusion of motion and a panning or scanning effect. The text effect option can include fade-in and fade-out options as well as flash, move in and out or marquee scroller effects. A user such as a sales representative can select from these various options and present them to the prospective customer and then make modifications to these options based on the prospective customer's preference.

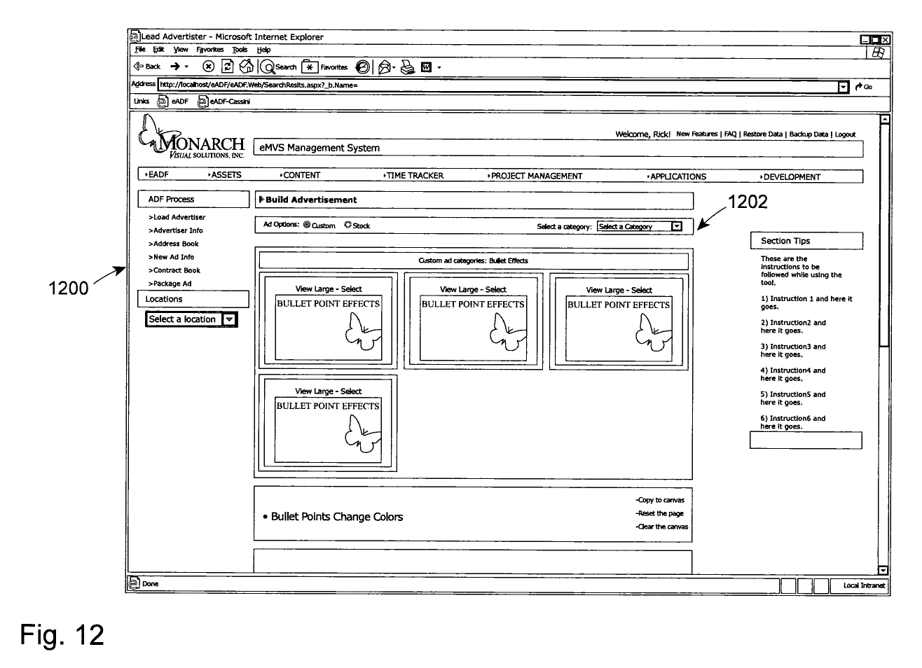

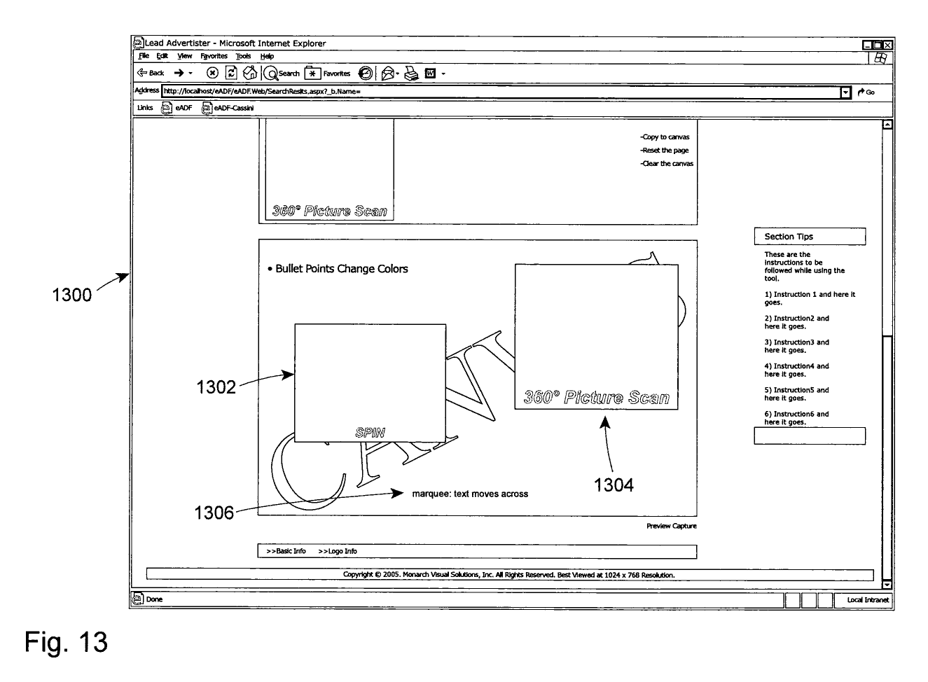

FIG. 12 is representative of a user interface screen shot where the user has selected the custom advertisement option 1200 and has selected the category of bullet effects 1202 where various bullet effect options are provided. FIG. 13 is representative of a user interface screen shot where the user has selected multiple options 1300 such as spin 1302 and 360 degree picture scan 1304 and marquee 1306 and presents the information to the prospective customer so that the customer can provide immediate feedback.

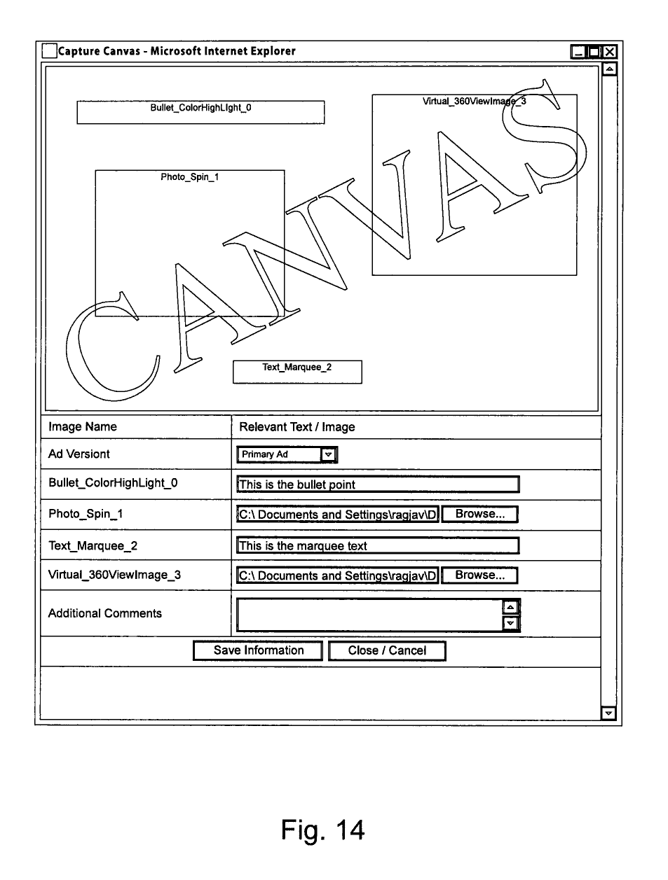

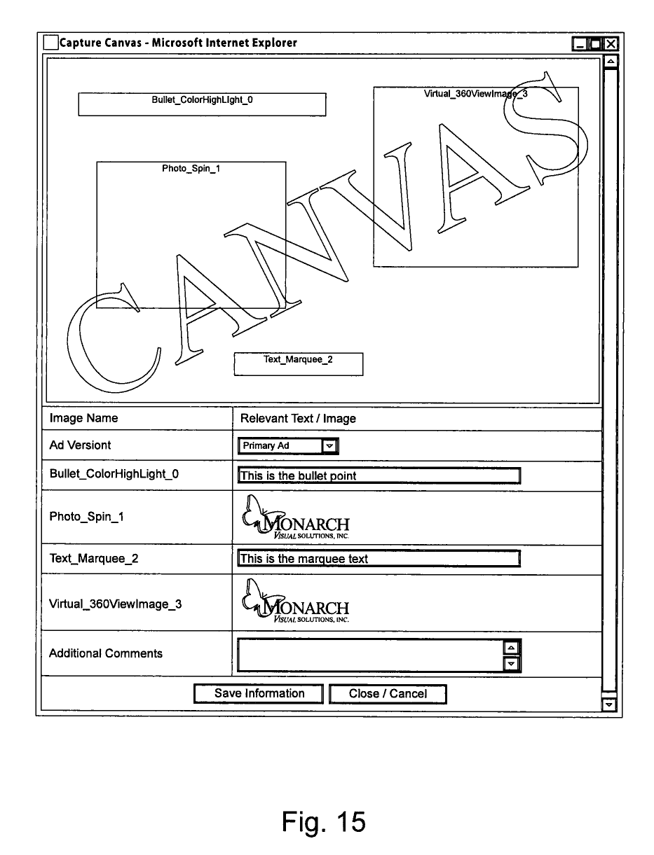

FIGS. 14 and 15 are representative of user interface screens shots that allow the user to input various information into a template in order to customize the graphical presentation. As shown, the user has the option of creating various image windows, each having a selected custom category. For example, as shown there are two windows having images, one of which is the virtual 360 degree image option and the other is the photo spin option. Once the graphical presentation meets the prospective customer's satisfaction, the information can be saved and captured in a canvas for future uploading/downloading to a network communicably linked to a network of electronic displays.

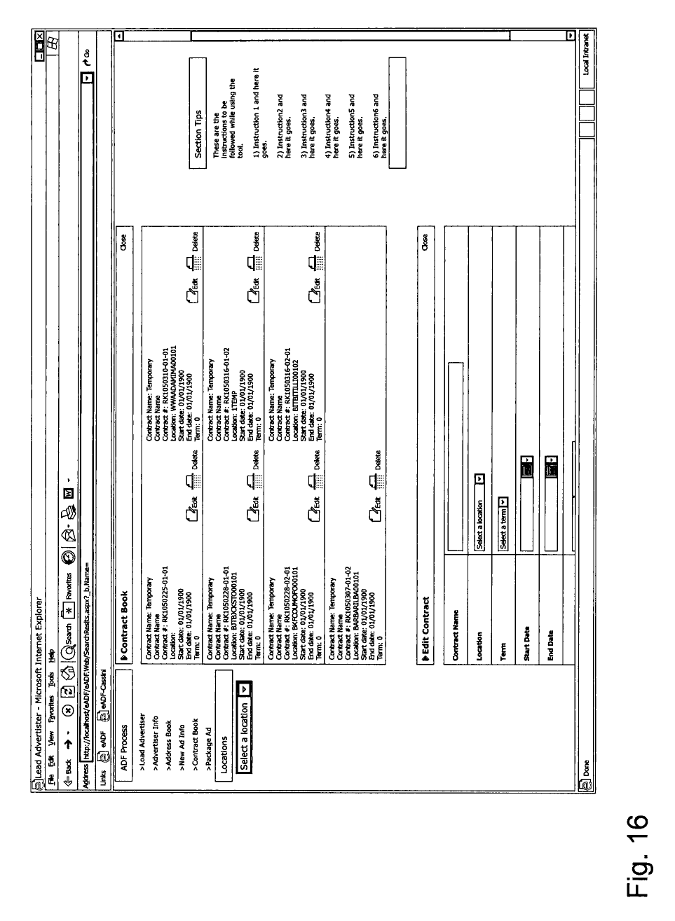

FIG. 16 is representative of a user interface screen shot that allows the user to finalize the contract with the prospective customer. Once the graphical presentation for the advertisement has been created, a contract can be created and referenced by a contract number. The contract would contain such information as the start date and end date of the advertisement and the location for which the advertisement is to be displayed. Once the contract has been completed, the information can be uploaded/downloaded to a centralized system that automatically schedules and fulfills the graphical presentation for the advertisement at the appropriate times and on the appropriate display locations.

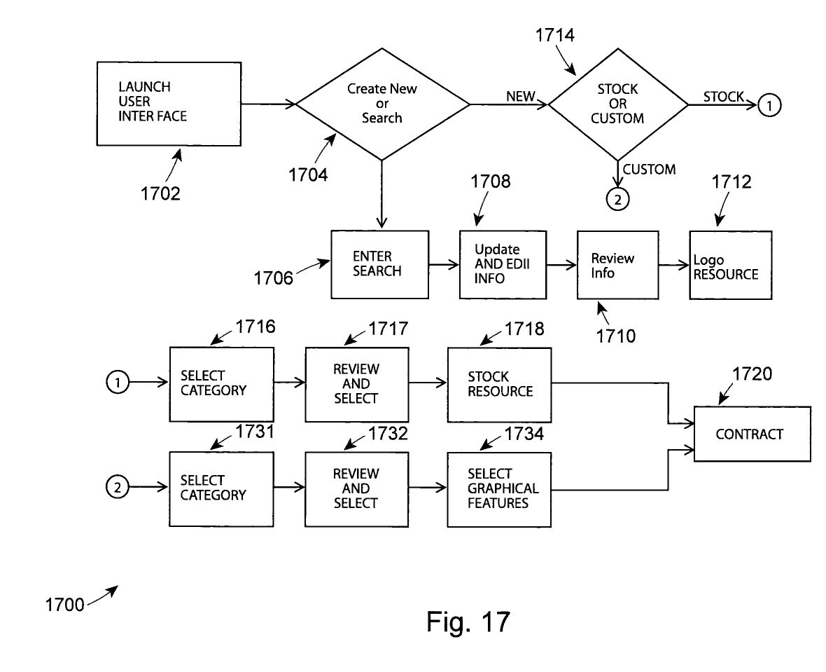

Referring to FIG. 17, a functional flow diagram of the computerized advertisement development tool user interface 1700 is shown. In the description of the functional flow diagram, the functional explanation marked with numerals in angle brackets, <nnn>, will refer to the flowchart blocks bearing that number. The first step in the user interface flow is to launch the user interface <1702> on a laptop computer or other computing device having an operating system, e.g., standard operating system. As indicated above, the development tool can be a browser-based application. After the application has been launched, the user interface presents to the user the option of creating a new advertisement or searching for a previously created advertisement <1704> that was previously stored. If the search option is selected then the next step is to enter the appropriate search parameters <1706> to identify the previously created advertisement. Once the previously created advertisement has been located, the user will then have the option to update and edit the information content <1708> of the selected advertisement. The user can then review the information and update <1710> and review the logo information that is currently available for this particular advertisement. This logo is then available as a resource <1712>.

Alternatively, if the user opts to create a new advertisement, then the next step is to present to the user the option of utilizing a stock advertisement or a custom advertisement <1714>. If the user selects the stock option, then the user is given the option to select from among various general categories of various business types <1716>. For example, the categories could include real estate, banking and other general categories. Once the user has selected a category <1717>, the user is then presented with various stock advertisements specifically geared toward the selected category. The user then has the option to review these stock advertisements and select from among them. The user also has the ability to review the stock resource options <1718> once an advertisement has been selected. Once the user has completed building the stock advertisement, the user is then presented with a contract template to be completed <1720>. The template will include all the pertinent information including the duration for which the advertisement is to be broadcast on the network of electronic displays.

Alternatively, if the user selects the custom option, then the user is given the option to select from among various general categories of various business types <1731>. Once the desired options have been selected, the user then has the ability to review and select from various graphical features to customize the advertisement presentation. Once the build process has been completed, the user then enters into the contract template and completes the contract with the appropriate information. For example, the categories could include real estate, banking and other general categories. Once the user has selected a category <1732>, the user can then select from a variety of graphical features <1734> to design the advertisement. Once the user has completed building the custom advertisement, the user is then presented with a contract template to be completed <1720>. The template will include all the pertinent information including the duration for which the customer advertisement is to be broadcast on the network of electronic displays.

Therefore, the template includes the timing for the duration of the advertisement and can be programmed in a sequence. An advertisement recited in this patent application is defined as including a wide variety of programming such as, but not limited to, a traditional product or service promotion; trivia, e.g., healthy eating tips, “did you know?” type facts, and any other comparable items to capture the customer's attention; community events; amber alerts, e.g., child abduction warnings; sponsor boards, weather, news, e.g., headline news; special notifications, e.g., in-house promotions, regional events, and so forth; and user-defined announcements, e.g., in-store promotions.

In an illustrative, but nonlimiting embodiment, a traditional product or service promotions, i.e., sponsored or advertisements are scheduled thru an ACT file(s) to play in a predetermined sequence. The program will give priority to these ads to make sure they are played at least as frequently as that provided for in a contract. A simplified, illustrative but nonlimiting, example of an ACT file, which is electronic panel instruction file associated with a particular advertisement, is reproduced in Table 1 below:

TABLE 1
Simplified ACT FILE EXAMPLE:

‘*************************************************************
‘SMYPERNYPE00101 Perry Marketplace Smyd Corporation
‘121 N. Center Street PO Box 7 Perry NY 14530- (585) 237-2910
‘*************************************************************
‘-------------------------------------------------------------
‘transition type = 1-8 compass direction 45 degree clockwise 9 = zoom 99=random
‘scroll = 1-4 clockwise 90 degrees scroll direction 1-4 < not used −20 to 20 left and right
‘show = 0 if shown, 1 if not shown
‘tagfile = filename of picture to show when middle button is pressed
‘panel pictures, [seconds to display], [transition type], [order], [file size], [fileID], [scroll
direction 1-4],
‘[speed of scroll],[doNotShow] true<>0 , tag file,[FullScreen] true<>0
AC1:All:StartTime=00:00
AC1:All:EndTime=23:59
AC1:All:DefaultAct=1
AC1:PN1:Left=0
AC1:PN1:Top=0
AC1:PN1:Width=100
AC1:PN1:Height=85
AC1:PN1:NUMADS=2
AC1:PN1:FILE=Statefarm_LisaCottone_001.swf,13,99,1,72100,,,,
0,,0,,,,,,AC1:PN1:FILE=Zeches_003.swf,13,99,2,582054,,,,0,,0,,,,,,
AC1:PN1:FILE=Zeches_003.swf,13,99,18,582054,,,,0,,0,,,,,,
AC1:PN1:FILE=ClimateControllers_001.swf,13,99,3,145293,,,,0,,0,,,,,,
AC1:PN1:FILE=PerrysAuto_003.swf,13,99,4,263387,,,,0,,0,,,,,,
AC1:PN1:FILE=SilverLake_001.swf,13,99,5,535579,,,,0,,0,,,,,,
AC1:PN1:FILE=Napa_PerryNY_001.swf,13,99,6,174022,,,,0,,0,,,,,,
AC1:PN1:FILE=BonadioGroup_002.swf,13,99,7,180274,,,,0,,0,,,,,,
AC1:PN1:FILE=g_207_021806.jpg,13,99,8,142916,,,,0,,0,,2/12/06,2/18/06,,,
AC1:PN1:FILE=Elitsac_001.swf,13,99,9,474373,,,,0,,0,,,,,,
AC1:PN1:FILE=Amy_Mattoon_003.swf,13,99,10,223049,,,,0,,0,,,,,,
AC1:PN2:Left=0
AC1:PN2:Top=85
AC1:PN2:Width=100
AC1:PN2:Height=15
AC1:PN2:FILE=MVSMarquee.jpg,999,,1,276173,,1,8
‘-------------------------------------------------------------
‘transition type = 1-8 compass direction 45 degree clockwise 9 = zoom 99=random
‘scroll = 1-4 clockwise 90 degrees scroll direction 1-4 < not used −20 to 20 left and right
‘show = 0 if shown, 1 if not shown
‘tagfile = filename of picture to show when middle button is pressed
‘panel pictures, [seconds to display], [transition type], [order], [file size], [fileID], [scroll
direction 1-4],
‘[speed of scroll],[doNotShow] true<>0 , tag file,[FullScreen] true<>0
‘-------------------------------------------------------------

The other types of advertisements such as that described above that are not sponsored or regular advertisements can be referenced as timed events. Preferably, but not necessarily, a timed event will play after a sponsored or regular advertisement or a block of sponsored or regular advertisements.

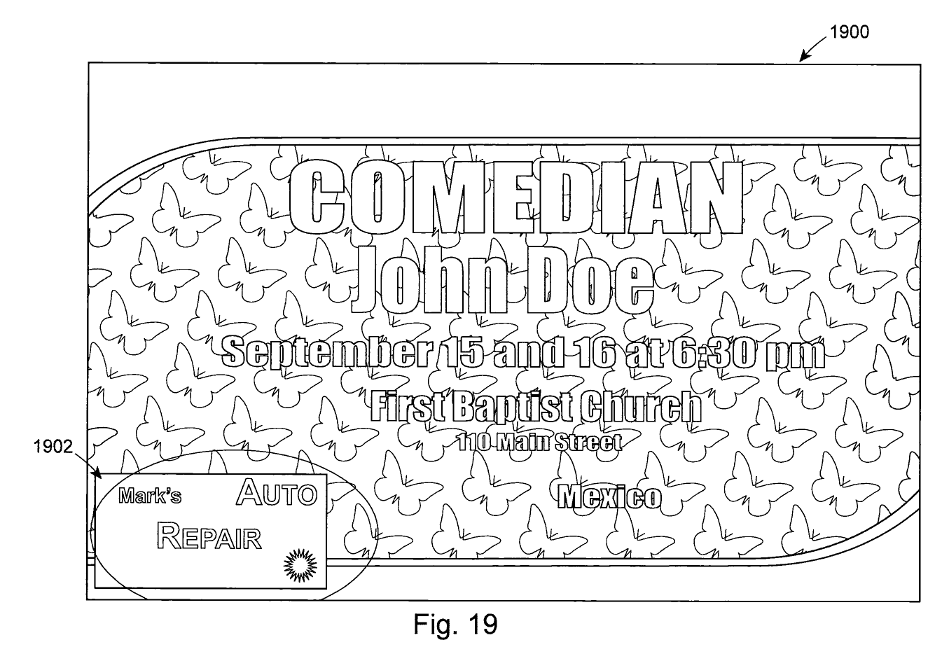

As previously referenced above, as explained with regard to FIG. 17, the user can then review the information and update <1710> and review the logo information that is currently available for this particular advertisement. Also, different logos and advertisers can sponsor various advertisements. Although this is typically not applicable to sponsored or regular advertisements, it can be applied to trivia, e.g., healthy eating tips, “did you know?” type facts, and any other comparable items to capture the customer's attention; community events; amber alerts, e.g., child abduction warnings; sponsor boards, weather, news, e.g., headline news; special notifications, e.g., in-house promotions, regional events, and so forth; and user-defined announcements, e.g., in-store promotions. An example of a community event is generally indicated by numeral 1900 in FIG. 19. A sponsor 1902 can stay the same or a new sponsor 1902 can be substituted each time the community event 1900 is played or after the community event 1900 is played a predetermined number of times. A simplified illustrative, but nonlimiting, example of an ACT file, which is an electronic panel instruction file associated with a particular template-type advertisement, e.g., a community event advertisement, having substitutable sponsors is reproduced in Table 2 below:

TABLE 2

‘background is the template (determines sponsor placement)
‘file is actual ad
‘3:BACKGROUND=ce_114_071505.jpg,79067,7/10/05,7/15/05
3:BACKGROUND=ce_207_021106.swf,59155,02/06/06,02/11/07
3:BACKGROUND=ce_207_020806.swf,56396,02/08/06,02/08/06
3:FILE=ce3fl_template.html,3826,10
4:BACKGROUND=ce_207_020306.swf,79512,01/26/06,02/03/07
‘4:BACKGROUND=ce_207_020106.swf,83445,01/31/06,02/01/06
4:FILE=ce4fl_template.html,3853,10

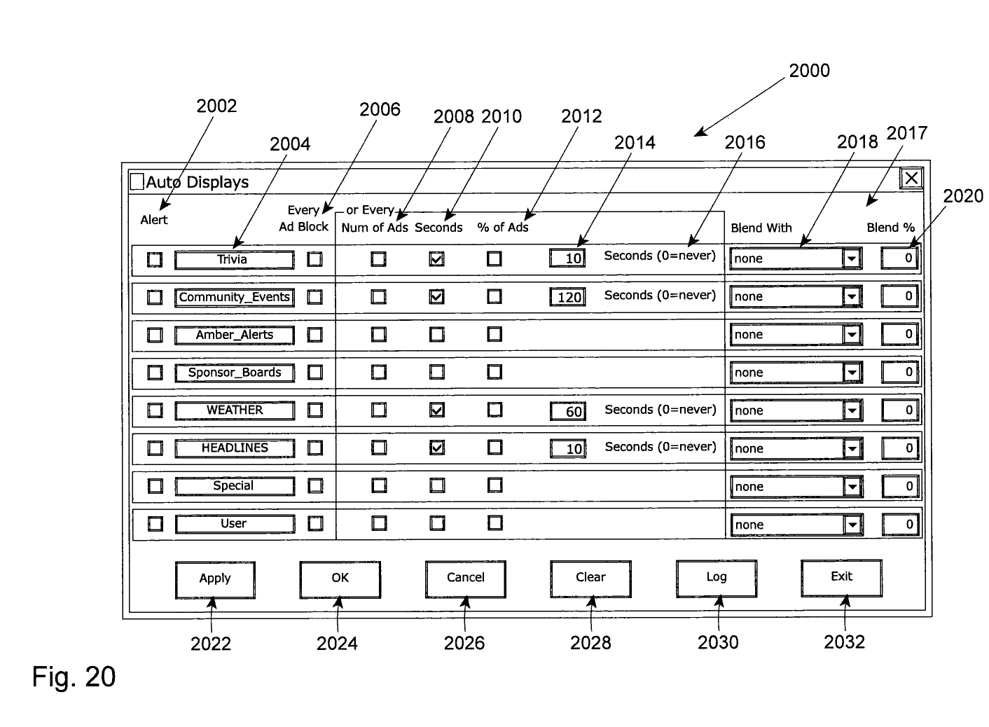

Referring now to FIG. 20, an illustrative interface that can be utilized with timed events is generally indicated by numeral 2000. There is a first column of click-on inputs 2002 for the purpose of activating a particular type of timed event. The second column 2004 is a listing (graphical output) of types of time events that are not sponsored or regular advertisements, e.g., trivia, community events, amber alerts, sponsor boards, weather, headlines, special events and user-created events. There is a column 2006 of click-on inputs that would allow a timed event to run after every block of sponsored or regular advertisement. In the alternative, the timed event 2004 can run after a predetermined number of sponsored or regular advertisements through a click-on input in column 2008 or the timed event 2004 can run after a predetermined number of seconds through a click-on input in column 2010 or the timed event 2004 can run after a predetermined percentage of sponsored or regular advertisements are played through a click-on input in column 2012.

There is a column to provide a numerical data input 2014 through which either the number of sponsored or regular advertisements 2008, the predetermined number of seconds 2010 or the predetermined percentage of sponsored or regular advertisements 2012 can be provided through input. Therefore, the number of sponsored or regular advertisements that will be played prior to a timed event is provided in column 2014 if the click-on input 2008 is activated, the predetermined number of seconds that sponsored or regular advertisements that will be played prior to a timed event will be provided in column 2014 if the click-on input 2010 is activated and the predetermined percentage of sponsored or regular advertisements that are played prior to a timed event is provided in column 2014 if the click-on input 2012 is activated. Graphical information 2016 regarding parameters and constraints regarding the data input 2012 is shown, e.g., time in seconds cannot equal (0) zero.

There is also a blending feature that provides for a blending of timed events that is generally indicated by numeral 2017. This includes a column of drop-down inputs 2018 to input another timed event. There is a column of data inputs 2020 to provide the percentage for the blending with the other timed event that is provided through the drop-down input 2018.

There is a: first pushbutton icon 2022 to apply changes to the timed events interface 2000; a second pushbutton icon 2024 to review and approve the current information in the timed events interface 2000; a third pushbutton icon 2026 to cancel the current information in the timed events interface 2000; a fourth pushbutton icon 2028 to clear the information and settings currently listed in the timed events interface 2000; a fifth pushbutton icon 2030 to create a log of the setting for the automatic display of timed events; and a sixth pushbutton icon 2032 to exit the timed events interface 2000.

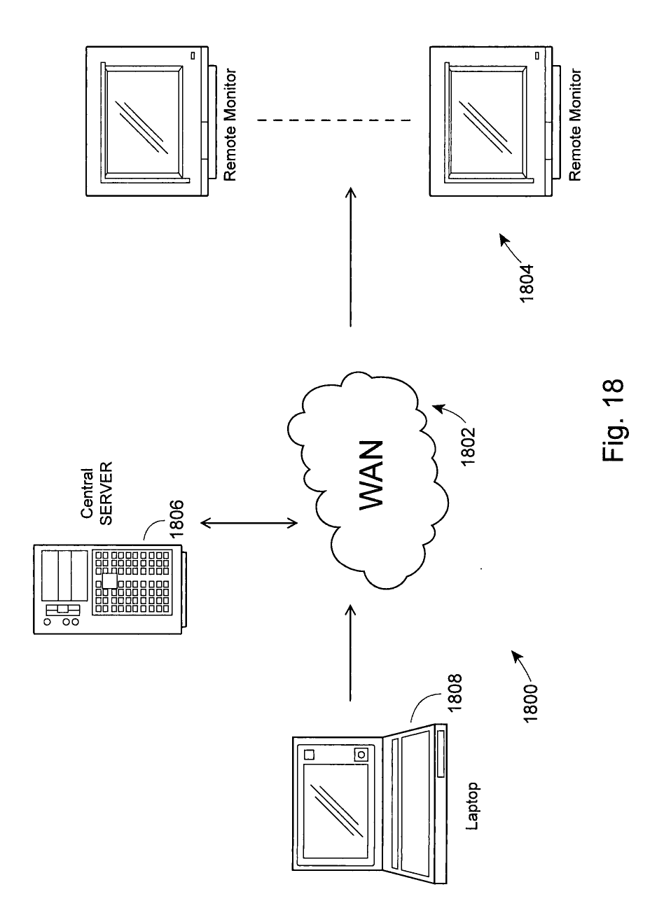

Referring to FIG. 18, a functional diagram of the computerized system 1800 is shown. The embodiment reflected in FIG. 18 reflects a wide area network 1802 having various remote monitors 1804, which are electronic displays, located at various different public locations. The wide area network shown in FIG. 18 also includes a central server 1806 which can host all data required to support the application for the user interface as well as having storage capability to upload the completed advertisement to be subsequently displayed on the remote monitors 1804. The wide area network also shows a laptop computer 1808, which can have a wireless interface for communicating information back and forth between a central server. The network can take on various embodiments without departing from the scope of the invention. For example, a local area network can also be utilized.

The various computerized advertisement tool examples shown above illustrate a novel and cost effective system and method for building graphical advertisement displays. A user of the present invention may choose any of the above computerized advertisement tool embodiments, or an equivalent thereof, depending upon the desired application. In this regard, it is recognized that various forms of the subject invention could be utilized without departing from the spirit and scope of the present invention.

Other aspects, objects and advantages of the present invention can be obtained from a study of the drawings, the disclosure and the appended claims. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “have,” “having,” “includes” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims that follow.

1. A computerized advertisement development tool comprising:
an advertising development processor to create at least one electronic advertisement in real time at a sponsor's location, wherein the at least one electronic advertisement includes a customized electronic advertisement including at least one of a bullet point effect, a photographic effect, a motion picture effect and a text effect or a stock background electronic advertisement in a particular category from a plurality of categories with newly entered text: and
an electronic communication system that is operatively connected to the advertising development processor that can receive the at least one uploaded electronic advertisement from the advertising development processor at the sponsor's location and provide it to an advertising display processor that is connected to at least one electronic display, which is physically located in a commercial establishment for the purpose of displaying electronic advertisements.

2. The computerized advertisement development tool according to claim 1, wherein the bullet point effect includes at least one of text that appears one line at a time, checkmarks by each line of text, a new color for each line of text, an appearance of all lines of text simultaneously and text sliding in from one side.

3. The computerized advertisement development tool according to claim 1, wherein the photographic effect includes at least one of a wipe effect for a photograph, a spin effect for a photograph, a fade-in effect for a photograph, a roll effect for a photograph and a fade-out effect for a photograph.

4. The computerized advertisement development tool according to claim 1, wherein the motion picture effect includes at least one of a video and a virtual motion image created from a plurality of still photographs.

5. The computerized advertisement development tool according to claim 1, wherein the text effects include at least one of fade-in, fade-out, flash, move-in, move-out, a marquee scroller, roll text and spin text.

6. The computerized advertisement development tool according to claim 1, wherein the advertising development processor includes a laptop processor, the electronic communication system includes at least one of a wireless network, a wide area network and a local area network and the advertising display processor includes a server.

7. The computerized advertisement development tool according to claim 1, further comprising a contract provided by data entered by the user to the advertising development processor that includes operational information associated with the at least one customized electronic advertisement such as timing, a start date and an end date for display of the at least one electronic advertisement.

8. The computerized advertisement development tool according to claim 7, wherein the contract provides scheduling between a plurality of sponsored electronic advertisements and a plurality of timed events.

9. The computerized advertisement development tool according to claim 8, wherein the plurality of timed events includes at least one of trivia, community events, amber alerts, sponsor boards, weather, headlines, special events and user-created events.

10. The computerized advertisement development tool according to claim 8, wherein the plurality of timed events provides at least one replacement of a sponsor for a particular timed event.

11. The computerized advertisement development tool according to claim 8, wherein the plurality of timed events are scheduled by one of the following techniques that include following after a block of sponsored electronic advertisements, playing after a predetermined number of sponsored electronic advertisements, playing after a predetermined time period, and playing after a predetermined percentage of sponsored electronic advertisements.

12. The computerized advertisement development tool according to claim 8, wherein at least one of a plurality of timed events can be blended with at least one other of the plurality of timed events based on a predetermined percentage.

13. A method for developing computerized advertisements comprising:
creating at least one electronic advertisement in real time at a sponsor's location with an advertising development processor, wherein the at least one electronic advertisement includes a customized electronic advertisement including at least one of a bullet point effect, a photographic effect, a motion picture effect and a text effect or the at least one electronic advertisement includes a stock background electronic advertisement in a particular category from a plurality of categories with newly entered text;
receiving the at least one uploaded electronic advertisement from the advertising development processor at the sponsor's location with an electronic communication system; and
providing the at least one uploaded advertisement to an advertising display processor that is electrically connected to at least one electronic display, which is physically located in a commercial establishment for purpose of displaying electronic advertisements.

14. The method for developing computerized advertisements according to claim 13, wherein the bullet point effect includes at least one of text that appears one line at a time, checkmarks by each line of text, a new color for each line of text, an appearance of all lines of text simultaneously and text sliding in from one side, wherein the photographic effect includes at least one of a wipe effect for a photograph, a spin effect for a photograph, a fade-in effect for a photograph, a roll effect for a photograph and a fade-out effect for a photograph, wherein the motion picture effect includes at least one of a video and a virtual motion image created from a plurality of still photographs, and wherein the text effects include at least one of fade-in, fade-out, flash, move-in, move-out, a marquee scroller, roll text and spin text.

15. The method for developing computerized advertisements according to claim 13, further comprising developing a contract based on data entered by the user to the advertising processor that includes operational information associated with an electronic advertisement such as timing, a start date and an end date for display of the electronic advertisement.

16. The method for developing computerized advertisements according to claim 13, further comprising providing scheduling between a plurality of sponsored electronic advertisements and a plurality of timed events, wherein the timed events includes at least one of trivia, community events, amber alerts, sponsor boards, weather, headlines, special events and user-created events.

17. The method for developing computerized advertisements according to claim 13, further comprising providing a plurality of replacements of a sponsor for a particular timed event.

18. The method for developing computerized advertisements according to claim 16, further comprises scheduling the plurality of timed events by one of the following techniques that include following after a block of sponsored electronic advertisements, playing after a predetermined number of sponsored electronic advertisements, playing after a predetermined time period, playing after a predetermined percentage of sponsored electronic advertisements, and blending at least one of a plurality of timed events with at least one other of the plurality of timed events based on a predetermined percentage.
